(19) United States
(12) Patent Application Publication
(10) Pub. No.: US 2008/0232651 A1
(43) Pub. Date: Sep. 25, 2008

(54) APPARATUS AND METHOD FOR DETECTING FACE REGION

(75) Inventor: Jung-Su WOO, Gyeonggi-do (KR)

Correspondence Address: THE RAFFERTY PATENT LAW FIRM, 5641 BURKE CENTRE PKWY, SUITE 100, BURKE, VA, 22015-2259, US

(73) Assignee: ARTNIX INC., Chungcheongnam-do (KR)

(21) Appl. No.: 12/052,025

(22) Filed: Mar. 20, 2008

(30) Foreign Application Priority Data
Mar. 22, 2007 (KR) 10-2007-0028037
Sep. 7, 2007 (KR) 10-2007-0091033

(51) Int. Cl. G06K 9/00

(52) U.S. Cl. 382/118; 382/224

(57) ABSTRACT

A face region detecting apparatus includes a face detection and recognition unit for encoding a face image into a face feature code through an internal operation process and storing the face feature code in the form of a database, in which the face image is extracted in a face detection step of extracting a face image from an inputted image material; and a face detection server for transmitting the face feature code through a network, comparing the transmitted face feature code with face feature codes previously stored in a database to determine whether face features are matched, and transmitting a face recognition result to the face detection and recognition unit. Accordingly, a face image of a specific person is converted into a face feature code, whereby the face feature code can be applied to recognize and detect the specific person or to search for only the specific person from a DVR real-time input image or a recorded image screen. Furthermore, an infrared LED and an infrared iris are provided in receiving an external image of a person, thereby making it possible to stably obtain a face image without being affected by uneven brightness distribution or inconsistent external light source environments.

### CROSS-REFERENCES TO RELATED APPLICATIONS

The benefit of priority of Republic of Korea patent applications KR 10-2007-0091033, filed Sep. 7, 2007, and KR 10-2007-0028037, filed Mar. 22, 2007, both applications being incorporated by reference herein in their entireties.

### INTRODUCTION

The present discussion relates to a method and system for inspecting and measuring a face, and more particularly, to a method and system for inspecting and measuring a face from a moving image screen inputted in real-time. Face recognition, which is one of bio-recognition methods, is an easy way to obtain data without reluctance to contact with a machine. A program for inspecting and measuring a face recognizes and digitizes featured positions, sizes and the like of a face from an inputted still or moving image. This technique recognizes synthesis, expression and the like of the face to detect and recognize a specific person and thus can be applied to prevention of crimes, interactions between a person and a robot, and the like.

In addition, the present discussion relates to an apparatus and method for detecting a face region, and more specifically, to a face region detecting apparatus provided with an infrared light emitting diode (LED) and an infrared iris to stably obtain a face image without being affected by uneven brightness distribution or inconsistent external light source environments, and to a method of detecting a face region using the face region detecting apparatus, wherein values of a face image can be rapidly and accurately detected in real-time from an external face image inputted in real-time in a method of detecting face information on the basis of a multi-step classification method.

### BACKGROUND

The human face is an important factor for visually distinguishing and identifying a person, and analysis on recognizing a face and interpreting expression of the face has been broadly studied from the past. Recently, techniques for searching for a face and identifying a person from a stream of images have been proposed. Particularly, such a face recognition technique is a technique for identifying a person from faces of one or more persons appearing in a still or moving image, using a given face database. Unlike other bio-recognition techniques such as finger-print recognition and the like, such a face recognition technique makes it possible to obtain bio-information without touching a part of a body to a recognition apparatus and does not resort to coercive measures to obtain the information. However, since a face in itself is liable to be shown differently depending on changes in illumination and posture and is particularly very sensitive to surrounding environments, the face recognition technique is disadvantageous in that ability of identifying a face is lower than that of the other bio-recognition systems.

Furthermore, the face recognition goes through a process of recognizing and digitizing featured positions, sizes and the like of a face from face images in a still or moving image inputted from a light source. The technique recognizes synthesis, expression and the like of the face and thus can be applied to prevention of crimes, interactions between a person and a robot, and the like.

The importance of face recognition is not on inputting images but on identifying input images. Typically, a direct recognition method and a statistical recognition method are used as a method of identifying a face from an input image.

In the direct recognition method, a rule is set up using physical features of a face image displayed on a screen, such as contour, skin color and size of constitutional parts of the face image, distances between the parts and the like, and the physical features are measured, inspected, and compared based on the rule. Although a method of grasping face images based on such a rule advantageously guarantees high identification speed, the method is lack of adaptability to changes of external environments, and thus recognition errors are severe.

The other method of recognizing a face is a method of using statistical expressions, in which unique features of an input face image are converted into data and analyzed by being compared with a prepared database with a large volume (shapes of faces and other objects). Such a method accurately recognizes a face even in unstable external environments. However, the method has a problem in that it takes too long a calculation time to identify a face in real-time, and a large amount of data is required.

Furthermore, conventionally commercialized face region identification methods use natural or illumination light when collecting images. However, in such methods, performance of identifying a face region is greatly affected by changes of light, and particularly, there will be a large difference in brightness distribution on a face image to be formed when the external light is changed. In addition, even when the external light is not changed, if other factors, such as front light, back light, polarized light or the like, occur on the illuminated face region, face identification is greatly affected by the factors, and there arises a critical problem in that desired high quality video images cannot be implemented.

### SUMMARY

The present discussion is conceived to solve the aforementioned problems. An object of the present discussion is to provide a face region detecting apparatus, in which a face image (FI) of a specific person is converted into a face feature code (FC), and the face feature code is applied to recognize and detect the specific person or to search for only the specific person from a digital video recorder (DVR) real-time input image or a recorded image screen, thereby making record, search and playback easy using the face image of the person.

Another object of the present discussion is to provide a method of detecting a face region, in which an infrared LED and an infrared iris are provided in receiving an external video image to thereby stably obtain a face image without being affected by uneven brightness distribution or inconsistent external light source environments, and values of the face image can be rapidly and accurately detected in real-time from an external face image inputted in real-time by the method of detecting face information on the basis of a multi-step classification method when detecting the face image.

The present discussion provides a face region detecting apparatus, which comprises a face detection and recognition (FDR) unit for encoding a face image (FI) into a face feature code (FC) through an internal operation process, wherein the face image is extracted in a face detection (FD) step of extracting a face image from an inputted image material, and the face feature code is stored in the form of a database; and a face detection server (FS) for transmitting the face feature code (FC) through a network, comparing the transmitted face feature code (FC) with face feature codes previously stored in a database to determine whether face features are matched, transmitting a face recognition result to the face detection and recognition unit, and managing the face recognition result, thereby recognizing and selecting an object to be detected.

Particularly, in a case where transmission speed is low depending on a transmission line or the face region detecting apparatus is used in a limited space, an external type face recognition (FR) module instead of the face detection server (FS) is directly connected to the face detection and recognition (FDR) unit to remove limitation on the location of the face region detecting apparatus and enhance efficiency in the speed of the face recognition function. That is, a modular type apparatus capable of performing the functions of the face detection server (FS) is externally connected to or embedded within the FDR unit, so that detection and recognition of a face can be allowed even in a close environment where a network or the like cannot be used.

### BRIEF DESCRIPTION OF THE DRAWINGS

FIG. 1 is a conceptual view showing a preferred embodiment according to the present discussion;

FIG. 2 is a conceptual view showing another embodiment of the present discussion;

FIG. 3 is a view showing an operational state of a face region detecting apparatus of the present discussion;

FIG. 4 is a conceptual view showing a further embodiment of the present discussion; and

FIG. 5 is a view showing the steps of detecting a face image according to the present discussion.

### DETAILED DESCRIPTION

A face region detecting apparatus according to the present discussion may include a face detection and recognition (FDR) unit for encoding a face image (FI) into a face feature code (FC) through an internal operation process and storing the face feature code in the form of a database, wherein the face image is extracted in a face detection (FD) step of extracting a face image from an inputted image material; and a face detection server (FS) for transmitting the face feature code (FC) through a network, comparing the transmitted face feature code (FC) with face feature codes previously stored in a database to determine whether face features are matched, and transmitting a face recognition result to the face detection and recognition unit.

According to such a configuration, the present apparatus has an advantage in that a face image (FI) of a specific person is converted into a face feature code (FC), whereby the face feature code (FC) can be applied to recognize and detect the specific person or to search for only the specific person from a DVR real-time input image or a recorded image screen. Furthermore, an infrared LED and an infrared iris are provided in receiving an external image of a person, thereby making it possible to stably obtain a face image without being affected by uneven brightness distribution or inconsistent external light source environments.

The present discussion, which is conceived to solve the problems described above, provides a face region detecting apparatus. The face region detecting apparatus comprises a face detection and recognition (FDR) unit for encoding a face image (FI) into a face feature code (FC) through an internal operation process, wherein the face image is extracted in a face detection (FD) step of extracting a face image from an inputted image material, and the face feature code is stored in the form of a database; and a face detection server (FS) for transmitting the face feature code (FC) through a network, comparing the transmitted face feature code (FC) with face feature codes previously stored in a database to determine whether face features are matched, and transmitting a face recognition result to the face detection and recognition unit. Accordingly, the present discussion makes it possible to encode a face of a specific person into a face feature code and efficiently identify inputted face information.

In addition, the face detection server (FS) may store the face feature code (FC) transmitted from the face detection and recognition (FDR) unit in its own database, receive information on the face image (FI) extracted by the face detection and recognition (FDR) unit, and separately store the information in the form of a database, thereby gradually enhancing preciseness and reliability of data and allowing further more clients to connect and use the face region detecting apparatus.

In addition, according to the present discussion, the face detection server (FS) is provided with a function capable of receiving an image from a camera additionally installed and connected to the face detection server (FS) or from a picture formed as a file without using the FDR apparatus, performing a face detection (FD) operation by itself, encoding a face image (FI) obtained through the face detection (FD) operation into a face feature code (FC), and adding, reinforcing, and managing the database, thereby making it possible to enhance the efficiency of the face detection server (FS).

Further, the face detection and recognition (FDR) unit may further include a digital video recorder (DVR) for converting image data into a digital signal within the face detection and recognition, thereby making it possible to perform a face detection operation on real-time images provided by the DVR of the face detection and recognition (FDR) unit or on images recorded and stored in the DVR.

Furthermore, the image inputted may be obtained by an infrared light emitting unit for irradiating an object with light from a light source and a camera for obtaining the infrared light, which is radiated from the infrared light emitting unit, reflects from the object, and is incident on the camera, thereby making it possible to stably obtain face images without being affected by an external light source.

Moreover, the camera may further include an infrared iris attached in front of the camera to filter light beams other than the infrared light, thereby making it possible to select a wavelength of the infrared light that is further efficient and stable for obtaining a video image.

In addition, the infrared iris may be configured to selectively filter light beams other than the infrared light, and selectively filters light beams having a central wavelength of 800 to 1000 nm, thereby making it possible to obtain a more accurate image of a face.

Also, a diameter of the infrared iris may be between 10 and 40 nm, and the infrared light emitting unit may be an infrared LED having a diameter of 10 to 40 nm, wherein a central wavelength of the infrared light may be between 800 and 1000 nm, thereby it is possible to have a structure efficient for obtaining a face image.

According the present discussion, there is provided a face region detecting apparatus, which comprises a face detection and recognition (FDR) unit for encoding a face image (FI) into a face feature code (FC) through an internal operation process, wherein the face image is extracted in a face detection (FD) step of extracting a face image from an inputted image material, and the face feature code is stored in the form of a database; and a face recognition module directly mounted on an outside of the face detection and recognition (FDR) unit through a USB, thereby comparing the face feature code (FC) transmitted from the face detection and recognition (FDR) unit with face feature codes previously stored in itself to determine whether face features are matched, and transmitting a face recognition result to the face detection and recognition unit. Therefore, the present discussion makes it possible to implement far faster search speed by mounting the face recognition module directly connected to the face detection and recognition (FDR) unit through the USB in an external type in a case where transmission speed is low due to a delay in a transmission line or the face region detecting apparatus is used only in a limited area. By introducing such a fast search system, reluctance of users is diminished and recognition speed is greatly improved as compared with conventional human recognition systems, such as iris recognition, finger print recognition, palm vein recognition, and the like, and thus, the face region detecting apparatus can be generally applied to entrance control systems.

In addition, the present discussion makes it possible to provide a method of inspecting a face region wherein the face recognition module may be mounted within the face detection and recognition (FDR) unit.

Also, according to the present discussion, there is provided a method of inspecting a face region, including:

(1) irradiating an object with infrared light from an infrared light source;

(2) allowing the infrared light to reflect from the object and inputting the reflected infrared light into a camera as a video image;

(3) extracting a face image (FI) from the inputted video image and encoding the extracted face image (FI) into a face feature code (FC) through an internal operation process, in a face detection and recognition (FDR) unit; and

(4) transmitting the face feature code (FC) to a face detection server (FS) through a network, comparing the transmitted face feature code (FC) with face feature code data stored in the face detection server to determine whether face features are matched, and transmitting a face recognition result to the face detection and recognition unit.

In addition, according to the present discussion, step (1) may be performed by an infrared LED, thereby enhancing the efficiency of obtaining a face image.

In addition, the video image in step (2) is a video image of the irradiated infrared light filtered by an infrared iris installed in front of the camera, which has a central wavelength of 800 to 1000 nm, thereby enhancing accuracy of the video image.

Further, in step (3), the inputted video image may be converted into data by searching and measuring information on a front face in real-time, which may be performed in a multi-step classifier by an Ada Boost calculation method. Thus, the present discussion makes it possible to enhance speed and accuracy of measurement while searching face images inputted in real-time by a method of performing statistics, classifying images, and dividing the images stepwise.

Furthermore, the process of converting the inputted video image into data may include:

(1) extracting a face screen from the video image inputted in real-time;

(2) deriving data values from the extracted face screen by repeating coarse and fine inspections on the face screen by the Ada Boost method;

(3) transmitting the data values derived in step (2) to an identifying position;

(4) determining face features based on the transmitted data values;

(5) determining geometrical positions of respective parts of a face for the determined face features and deriving a final face screen by equalizing variation of brightness between left and right sides of the face; and

(6) deriving an image matching to a standard face screen by rotating, enlarging, and reducing the face screen derived in step (5).

Hereinafter, the configuration and operation of the present discussion will be described in detail with reference to the accompanying drawings.

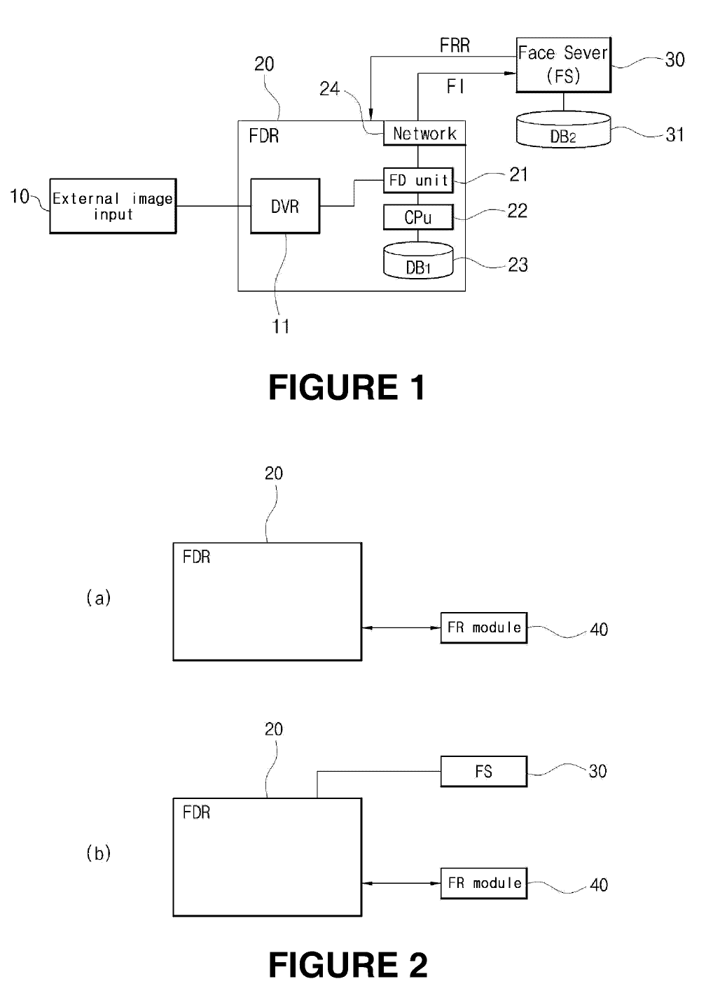

Referring to FIG. 1, a face region detecting apparatus according to the present discussion comprises a face detection and recognition (FDR) unit 20 for encoding a face image (FI) into a face feature code (FC) through an internal operation process and storing the face feature code in the form of a database, wherein the face image is extracted in a face detection (FD) step for extracting a face image from an inputted image material 10; and a face detection server (FS) 30 for transmitting the face feature code (FC) through a network, comparing the transmitted face feature code (FC) with face feature codes previously stored in a database to determine whether face features are matched, and transmitting a face recognition result (FRR) to the face detection and recognition unit.

The face detection and recognition (FDR) unit 20 preferably includes a face detection (FD) unit 21 for performing an internal operation process to encode a face image (FI), i.e., a face image of a person basically detected from an external input image, into a face feature code (FC), a database DB1 for storing the face feature code, and a central processing unit (CPU) 22 for controlling a series of basic operations.

The face detection server (FS) 30 connected to the face detection and recognition unit 20 through a network, i.e., the Internet or a LAN network, receives the face feature code (FC) of the encoded input image from the face detection and recognition unit 20, compares the received face feature code with face feature codes previously stored in an internal database DB2 to determine whether there is a face feature code matched to the received face feature code, and transmits a result of the comparison to the face detection and recognition unit 20. If the face feature code of the external input image is matched to a previously stored face feature code, a value of face recognition result (FRR) indicating that they are matched is transmitted to the face detection and recognition unit 20.

In addition, an internal database is separately constructed in the face detection server 30 as described above, and furthermore, it is preferable that inputted new face feature codes (FC) are stored in the database to update the database with new information.

The aforementioned face detection server 30 serves to receive the face feature code (FC), i.e., the face image (FI) encoded by the face detection and recognition unit 20, compare the received face feature code with the previously stored face feature codes, and transmit the face recognition result. Furthermore, the face detection server (FS) 30 preferably also converts a face image (FI) into a face feature code (FC) in itself through a face detection operation.

Such a function of the face detection server (FS) contained in itself can be allowed by attaching a camera (e.g., a USB camera for a PC) or an image capture apparatus capable of receiving an external image to the face detection server (FS) and directly receiving an image input therefrom or receiving an image from a picture stored in the form of a file, and then by performing face detection (FD) process on the received image containing faces through a face detection apparatus embedded within the face detection server (FS) in the form of a software program.

The face image (FI) extracted through the face detection (FD) process in the face detection server (FS) may be used in the face detection server (FS) without limitation, like the face image (FI) extracted in the face detection and recognition (FDR) unit. That is, a face image (FI) can be extracted through the face detection (FD) process in face detection server itself, so that the face detection server (FS) can maximize the efficiency of adding, reinforcing, and managing its own database using the face image (FI) obtained without using an external face detection apparatus.

Preferably, the face detection and recognition (FDR) unit 20 further includes a digital video recorder (DVR) for converting image signals to digital signals. In this case, if there is an external image input 10 as shown in FIG. 1, the external image is converted into digital signals through the DVR 11. The face detection and recognition (FDR) unit is preferably manufactured to extract a face image from the image provided by the DVR. This will be the foundation that makes it possible to search for and recognize a specific person through a face feature code using a face region detecting apparatus according to the present discussion, which will be described below.

Referring to FIG. 2, in the present discussion, it is preferable that the face detection and recognition (FDR) unit 20 be manufactured to connect to a separate external type face recognition (FR) module through a USB or the like to detect and recognize a face region in it self without using a face detection server (FS). The external face recognition module 40 having a function of the face detection server (FS) shown in FIG. 1 provided therein functions as a substitution type face detection server (FS) provided in an external detachable form when there is a problem in transmission speed due to a fault in a transmission line, use in a limited place, or the like, or when there is a limitation in use. Although the external face recognition module 40 may be provided as a detachable type, it may be formed as an internal type embedded in the face detection and recognition (FDR) unit 20.

Further preferably, when a client having the face detection and recognition (FDR) unit is connected through the Internet or a LAN network, both of the face detection server (FS) and the external face recognition module 40 are simultaneously used to handle a large number of clients (FIG. 2(b)).

Such an external face recognition (FR) module is widely used, so that the external face recognition (FR) module can be applied to a door control system, TX and RX for an IP camera, door lock, key lock of a vehicle, and the like, thereby making it possible to substitute for conventional iris recognition, finger print recognition, palm vein recognition by removing reluctance of clients and greatly enhancing recognition speed.

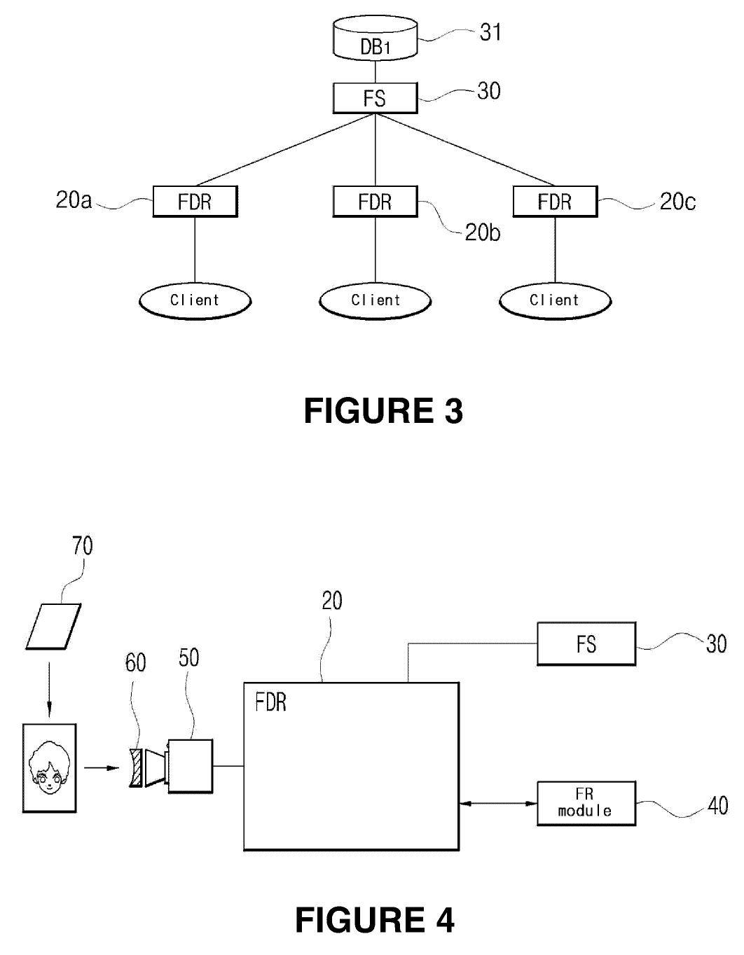

FIG. 3 is a conceptual view showing an example where external clients having the face detection and recognition (FDR) unit utilize a face detection operation.

Referring to FIG. 3, a plurality of clients is provided with a face detection and recognition (FDR) unit 20 connected to the face detection server 30 storing information on face feature codes (FC) constructed as a database DB2 as described above and transmits a face feature code (FC) to the face detection server (FS) 30 to confirm and search for a specific person, in which the face feature code corresponds to personal information desired to be confirmed in an image signal inputted into the face detection and recognition (FDR) unit 20 through an image input apparatus of their own, such as a DVR provided in the face detection and recognition (FDR) unit 20, an external surveillance camera, or the like.

It is apparent that overall processing capacity and search speed of the system will be greatly improved if the external face recognition (FR) module is attached to the face detection and recognition (FDR) unit together with the face detection server (FS) as shown in FIG. 2.

In an apparatus receiving an external image, a system that photographs an external image using a camera, inputs the external image into the face detection and recognition (FDR) unit 20 according to the present discussion, and detects a face will be described in detail in reference to FIG. 4.

The unit for receiving an external image most fundamentally comprises three parts of a camera 50, an infrared iris 60, and an infrared light emitting unit 70. As the infrared light emitting unit, an infrared LED is preferably used. The infrared iris 60 filters natural light and is preferably formed in a structure to be attached to the front of the lens of the camera 50.

Particularly, the infrared iris 60 is preferably manufactured to have a central wavelength of 800 to 1000 nm and a diameter of 40 nm. In addition, the infrared LED 70 is preferably selected to have a central wavelength of 800 to 1000 nm and a diameter of 40 nm.

The operation of the constitutional components will be described. First of all, a light source of the infrared LED 70 illuminates an object or a face. Then, the light beam reflects and is filtered through the infrared iris 60 placed in front of the camera 50. Specifically, the infrared iris 60 filters frequency light beam, such as natural light, an external light source, and the like, except light source frequencies of the infrared light. Finally, the filtered light is projected into the camera 50, so that a video image of the face is obtained. It is apparent that the obtained video image needs to be transferred to an electronic processing facility appropriate to the video image and processed to identify a face image. Generally, since disturbance of external natural light such as back light, polarized light, and the like is extremely small considering capability of the infrared LED, disturbance of natural light may be regarded as to be almost none, and thus, a face image is obtained entirely depending on the operation of the infrared LED.

The face detection and recognition (FDR) unit 20 forms a face image by extracting a portion corresponding to a face of a person from the image signals inputted from the camera 50 and extracts a face feature code (FC) through an internal operation process. The face detection and recognition (FDR) unit comprises a face detection (FD) unit, a database, central processing unit, and the like as shown in FIG. 1. Particularly, the face detection (FD) unit preferably uses an integrated circuit (IC) specially designed for digital signal processing (DSP) or FD functions for the efficiency of FD operation.

Hereinafter, a method of applying the present discussion will be described in detail through an embodiment of a method for using the face region detecting apparatus according to the present discussion.

1. Application to Theft Prevention Function

In the face region detecting apparatus according to the present discussion, a function of classifying face images by a face feature code may be used for general purposes. For example, if a person approaching a camera wears a mask on the face or hides the face with something, a face feature code (FC) will not be extracted. Therefore, a problem of a conventional DVR having a simple recording function by a sensor can be solved.

For example, it is possible to prevent a case where most of persons who are supposed to be a suspect wear a mask or hide their faces and cannot be identified when image materials of a DVR installed in an automatic teller machine (ATM) are searched ex post facto. If a person wearing a mask tries to withdraw cash from the ATM and a face feature code (FC) is not extracted by the face detection and recognition (FDR) unit, the function of the ATM is reinforced not to allow withdrawal of cash, so that thefts and crimes can be prevented.

2. Recording Only Specific Person

Particularly, if a user sets a face feature code (FC) of a specific person or a plurality of specific person group, it can be advantageous in that recording time of a DVR can be greatly extended, as compared with that of a conventional DVR, by recording only the images from which the set face feature codes (FC) are extracted. That is, the present discussion provides a method of using the face region detecting apparatus, in which images are recorded only when the face region detecting apparatus based on a face feature code of a specific person recognizes faces of persons whose face feature codes are matched to the face feature code of the specific person. When it is necessary to record an appearance of the specific person or the like to prevent a crime using the method, a medium having a recording function, such as a DVR or the like, is connected, and the recording function is operated to record the face only when a person matching to the face feature code (FC) of the specific person appears, thereby implementing generalization of its utility.

3. Search for Only Specific Person from Recorded Image

Only a specific person can be searched for from recorded images using the face region detecting apparatus according to the present discussion.

For example, the face of a desired specific person is detected from face information of a plurality of persons contained in a sequential image material stored in a DVR by the face region detection method, and a face image (FI) detected as a result of the face detection (FD) is encoded into a face feature code (FC). The face information is classified by the face feature code, and only the portions of the image material where the specific person appears are searched for, and the searched portions can be selectively displayed or separately stored. Therefore, it is possible to utilize the face feature code (FC) as a search index for moving to a portion where the specific person appears among a group of various persons stored in the DVR, or for selecting only an image portion related to the specific person, thereby providing a new kind of utility for searching for a specific person.

Specifically, in order to view a desired scene from a recorded image material of a very large volume in a conventional method, the image material should be rewound to the scene of a desired recording time, and images recorded at the time point are displayed.

However, if the method of the present discussion is used, using the face feature code (FC) of a specific person having a face image appearing in a recorded image material, only the images of a portion where the specific person having the face feature code (FC) appears are directly searched for and displayed among a group of persons appearing in the corresponding image material.

In this case, it is apparent that the recorded material to be searched may be recorded in the DVR provided in the face detection and recognition (FDR) unit of the present discussion or received from an external image apparatus.

4. Extract Specific Person from Person Group

According to the present discussion, if surveillance cameras installed in a stadium crowded with a large number of people, a convenience store where many people come and go, or the like are connected to the face detection and recognition (FDR) unit and the face detection server (FS) of the present discussion, and images of the people are recorded or received through the cameras, a desired person can be searched for by analyzing image signals of the crowd and encoding face features of the respective persons.

Accordingly, for example, if the present discussion is utilized to detect the face of a criminal suspect, the face feature code (FC) of the desired suspect and the face feature code (FC) of a specific person captured in an image are compared in the database of the face detection and recognition (FDR) unit or the face detection server (FS). Then, an FC matching rate (%) of the currently inputted face feature code (FC) to the face feature code (FC) of the suspect (a person previously recorded in the database) is displayed on a monitor together with general records of the suspect, so that additional information on the person captured in the current input image or a person having a FC matching rate higher than the displayed FC matching rate may be provided and displayed to an apparatus manager or supervisor.

Hereinafter, a method of detecting a face image (FI) in the aforementioned face region detecting apparatus of the present discussion will be described. This is a method of inspecting and measuring a face from an input image in real-time, which is performed in the sequence described below.

After an external image is inputted, faces are inspected and measured from the input image using the method of inspecting and measuring a face. It is apparent that the external image input is implemented by image signals recorded in a DVR or includes video image input of a camera through an infrared light source as described above.

A front face is inspected and measured in real-time by the method of inspecting and measuring a face of an Ada Boost statistical classifier.

Specific steps of performing the method of inspecting and measuring a face are as follows:

(a) Using the method of inspecting and measuring a face from an inputted moving image, faces are inspected and measured from a screen, and the faces are inspected and measured once again.

(b) The method of inspecting and measuring a face from a moving image screen described in step (a) is implemented by a multi-step classifier of an Ada Boost calculation method.

(c) The method of inspecting and measuring a face from a moving image screen described in step (b) is characterized by the following sequence.
i) Receive a moving image, ii) extract a face, iii) confirm features of the extracted face, iv) geometrically digitize the face, and v) rotate, reduce, and enlarge the face on the screen.

(d) A standard face screen is obtained to inspect and measure a face.

(e) The method of inspecting and measuring a face from a moving image screen described in step (c) is characterized by inspecting and measuring the face after removing brightness variation between the left and right sides of the face from the inputted face screen.

(f) In the step of reducing and enlarging the real-time face screen displaying the face inspected and measured from a moving image screen described in step (c), fine features of the face image are calculated, classified, and determined. Important positions, distances, and fine features of the face are obtained by performing integration and square integration of digitized face values.

(g) The method of inspecting and measuring a face from a moving image screen described in step (a) comprises two steps of coarse inspection and measurement and fine inspection and measurement. In this case, density of inspection in the fine inspection and measurement is higher than that of the coarse inspection and measurement.

(h) In the coarse inspection and measurement method described above, a face screen is extracted, enlarged, and reduced, and data satisfying certain conditions are extracted from a prepared database. Then, variation of brightness of the inputted face screen is modified using the brightness geometry square difference calculation method, which calculates fine features of appearance from a given screen based on Ada Boost, and the face screen is simultaneously sent to a classification part to be determined. A result of the determination is transferred to the CPU ARM, which is the next step.

(i) A result of the method of inspecting and measuring a moving image described in step (h) is displayed on the screen.

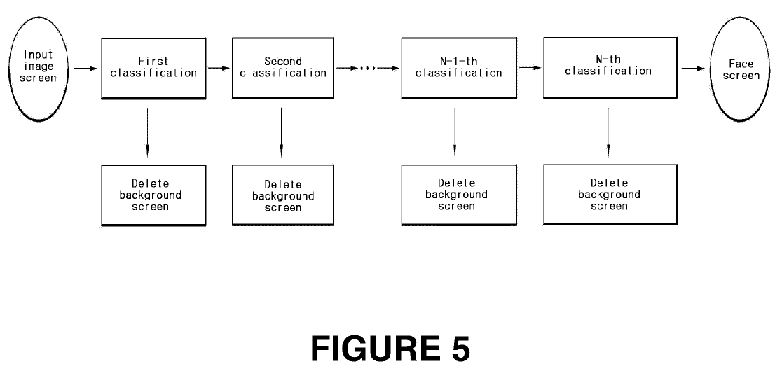

Referring to FIG. 5, FIG. 5 briefly shows input of an image screen and a flow of inspection and measurement implemented in a multi-step classifier by the Ada Boost method. The method of performing statistics, classifying images, and dividing the images stepwise based on the Ada Boost according to a preferred embodiment of the present discussion is advantageous in that moving images inputted in real-time are easily inspected and measured since the speed of the inspection and measurement is high. Also, errors occurring due to unbalanced illumination can be prevented by removing variation of brightness between the left and right sides of the face.

The face image (FI) extracted as such is converted into a face feature code (FC) through an internal operation process and then stored in a database. Although typical examples of utilizing the face feature code (FC) as a face recognition data are described in most of the aforementioned processes, it is apparent that the face image (FI) extracted in the step before the face feature coding step may be utilized as face recognition data.

According to the present discussion, a face image (FI) of a specific person is converted into a face feature code (FC), whereby the face feature code (FC) can be applied to recognize and detect a specific person or to search for only a specific person from a DVR image screen to easily detect and search for a face image of a person. If the method is applied, a specific person is easily searched for at an automatic teller machine, public institute, airport, and the like, so that security operation or search of a person can be efficiently performed.

According to the present discussion, there is an advantage in that a face image (FI) of a specific person is converted into a face feature code (FC), whereby the face feature code (FC) can be applied to recognize and detect a specific person or to search for only a specific person from a DVR image screen to easily detect and search for a face image of a person.

Furthermore, according to the present discussion, an infrared LED and an infrared iris are provided in receiving an external image of a person, thereby making it possible to stably obtain a face image without being affected by uneven brightness distribution or inconsistent external light source environments.

Particularly, according to the present discussion, values of the face image can be rapidly and accurately detected in real-time from an external face image inputted in real-time by the method of detecting face information on the basis of a multi-step classification method when detecting the face image.

What is claimed is:

1. A face region detecting apparatus, comprising:
a face detection and recognition unit configured to encode a face image into a face feature code through an internal operation process, the face image being extracted in a face detection of extracting a face image from an inputted image material, the face feature code being stored in a database; and
a face detection server configured to transmit the face feature code through a network, to compare the transmitted face feature code with face feature codes previously stored in a database to determine whether face features are matched, and to transmit a face recognition result to the face detection and recognition unit.

2. The apparatus as claimed in claim 1, wherein the face detection server stores the face feature code transmitted from the face detection and recognition unit in its own database, receives information on the face image extracted by the face detection and recognition unit, and separately stores the information in the form of a database.

3. The apparatus as claimed in claim 1, wherein the face detection server performs a face detection operation by itself, encodes a face image obtained through the face detection operation into a face feature code, and stores the face feature code in the form of a database.

4. The apparatus as claimed in claim 1, wherein the face detection and recognition unit further includes a digital video recorder that converts image data into a digital signal within the face detection and recognition.

5. The apparatus as claimed in claim 4, wherein the inputted image is obtained by an infrared light emitting unit that irradiates an object with light from a light source and a camera that obtains the infrared light, which is radiated from the infrared light emitting unit, reflects from the object, and is incident on the camera.

6. The apparatus as claimed in claim 5, wherein the camera further includes an infrared iris attached in front of the camera to filter light beams other than the infrared light.

7. The apparatus as claimed in claim 6, wherein the infrared iris is configured to selectively filter light beams other than the infrared light, and selectively filters light beams having a central wavelength of 800 to 1000 nm.

8. The apparatus as claimed in claim 7, wherein a diameter of the infrared iris is between 10 and 40 nm, and the infrared light emitting unit is an infrared light emitting diode having a diameter of 10 to 40 nm, a central wavelength of the infrared light being between 800 and 1000 nm.

9. A face region detecting apparatus, comprising:
a face detection and recognition unit configured to encode a face image into a face feature code through an internal operation process, the face image being extracted in a face detection of extracting a face image from an inputted image material, the face feature code being stored in the form of a database; and
a face recognition module directly mounted on an outside of the face detection and recognition unit through a USB, and configured to compare the face feature code transmitted from the face detection and recognition unit with face feature codes previously stored in the face recognition module to determine whether face features are matched, and to transmit a face recognition result to the face detection and recognition unit.

10. The apparatus as claimed in claim 9, wherein the face recognition module is mounted within the face detection and recognition unit.

11. A method of inspecting a face region, comprising:
irradiating an object with infrared light from an infrared light source;
allowing the infrared light to reflect from the object and inputting the reflected infrared light into a camera as a video image;
extracting a face image from the inputted video image and encoding the extracted face image into a face feature code through an internal operation process, in a face detection and recognition unit; and
transmitting the face feature code to a face detection server through a network, comparing the transmitted face feature code with face feature code data stored in the face detection server to determine whether face features are matched, and transmitting a face recognition result to the face detection and recognition unit.

12. The method as claimed in claim 11, wherein the irradiating is performed by an infrared light emitting diode.

13. The method as claimed in claim 11, wherein the video image in the allowing is a video image of the infrared light filtered by an infrared iris installed in front of the camera, the infrared light having a central wavelength of 800 to 1000 nm.

14. The method as claimed in claim 11, wherein in the extracting, the inputted video image is converted into data by searching and measuring information on a front face in real-time, performed in a multi-step classifier by an Ada Boost calculation method.

15. The method as claimed in claim 14, wherein the process of converting the inputted video image into data comprises:
extracting a face screen from the video image inputted in real-time;
deriving data values from the extracted face screen by repeating coarse and fine inspections on the face screen by the Ada Boost method;
transmitting the data values derived in the deriving to an identifying position;
determining face features based on the transmitted data values;
determining geometrical positions of respective parts of a face for the determined face features and deriving a final face screen by equalizing variation of brightness between left and right sides of the face; and
deriving an image matching to a standard face screen by rotating, enlarging, and reducing the face screen derived in the determining geometrical positions.

16. A face region detecting apparatus, comprising:
means for performing the method according to claim 11.
